(19) United States
(12) Patent Application Publication
(10) Pub. No.: US 2022/0207622 A1
(43) Pub. Date: Jun. 30, 2022

(54) FORAGE LOSS MONITORING

(71) Applicant: AGCO Corporation, Duluth, GA (US)

(72) Inventor: Kevin J. Hamilton, Newton, KS (US)

(21) Appl. No.: 17/645,948

(22) Filed: Dec. 23, 2021

Related U.S. Application Data
(60) Provisional application No. 63/131,331, filed on Dec. 29, 2020.

(51) Int. Cl. G06Q 50/02; G06Q 10/06

(52) U.S. Cl. CPC G06Q 50/02; G06Q 10/06316

(57) ABSTRACT

In one embodiment, a method for use in a farming operation comprising plural stages grouped over a first time period, the farming operation implemented over at least the first time period and a second time period, the method comprising: during the first time period: receiving first parameter information and first field position information corresponding to the first parameter information concerning a first stage; receiving second parameter information and second field position information corresponding to the second parameter information concerning a second stage, the first and second parameter information comprising quality information; determining a difference between the first and second parameter information; and effecting or recommending a change in the farming operation based on the difference.

### CROSS REFERENCE TO RELATED APPLICATION

This application claims the benefit of U.S. Provisional Application No. 63/131,331, filed Dec. 29, 2020, which is hereby incorporated by reference in its entirety.

### TECHNICAL FIELD

The present disclosure is generally related to farming operations and, more particularly, agricultural machines and systems for handling forage harvesting.

### BACKGROUND

It is widely recognized in the forage industry and academia that large losses in forage quality (e.g., relative feed value corresponding to how much of what an animal eats can be digested) and tonnage can occur during the harvesting process, especially for high value forage crops such as alfalfa or lucerne. These losses essentially span from the time plants are standing in the field ready to be swathed to the time the resulting feed gets to the animal. In general, the forage harvesting process can be broken down into several stages, including swathing, an optional tedding (e.g., to spread the windrow to maximize drying and foster sun exposure to underlying plants), raking (e.g., to drag the cut crop material on the ground to form windrows) or merging (e.g., forming a windrow using a conveyor to reduce ash/dirt collection and/or plant stand damage), and baling. Currently, forage harvesting operations are inadequate in the tools needed to significantly stem these losses. For instance, deciding on when or how to run a swather may be different depending on the experience level of an operator or farmer, and is often based on no more than subjective observation of current weather and/or crop conditions.

### BRIEF DESCRIPTION OF THE DRAWINGS

Many aspects of certain embodiments of a loss monitoring system and method can be better understood with reference to the following drawings. The components in the drawings are not necessarily to scale, emphasis instead being placed upon clearly illustrating the principles of the present systems and methods. Moreover, in the drawings, like reference numerals designate corresponding parts throughout the several views.

FIG. 1 is a schematic diagram that illustrates, in side elevation view, an example agricultural machine that may be used in an embodiment of a loss monitoring system.

FIG. 2 is a schematic diagram that illustrates, in side elevation view, another example agricultural machine that may be used in an embodiment of a loss monitoring system.

FIG. 3 is a schematic diagram that illustrates, in side elevation view, another example agricultural machine that may be used in an embodiment of a loss monitoring system.

FIG. 4 is a schematic diagram that illustrates, in side elevation view, another example agricultural machine that may be used in an embodiment of a loss monitoring system.

FIG. 5 is a block diagram that illustrates one embodiment of an example loss monitoring system used for plural machines in a farming operation.

FIG. 6 is a block diagram that illustrates one embodiment of an example loss monitoring system for a machine used for one or more stages of a farming operation.

FIG. 7 is a block diagram of an embodiment of an example computing device used in a loss monitoring system.

FIG. 8 is a schematic diagram of an example quality map that may be provided by a loss monitoring system.

FIG. 9 is a flow diagram that illustrates an embodiment of an example loss monitoring method.

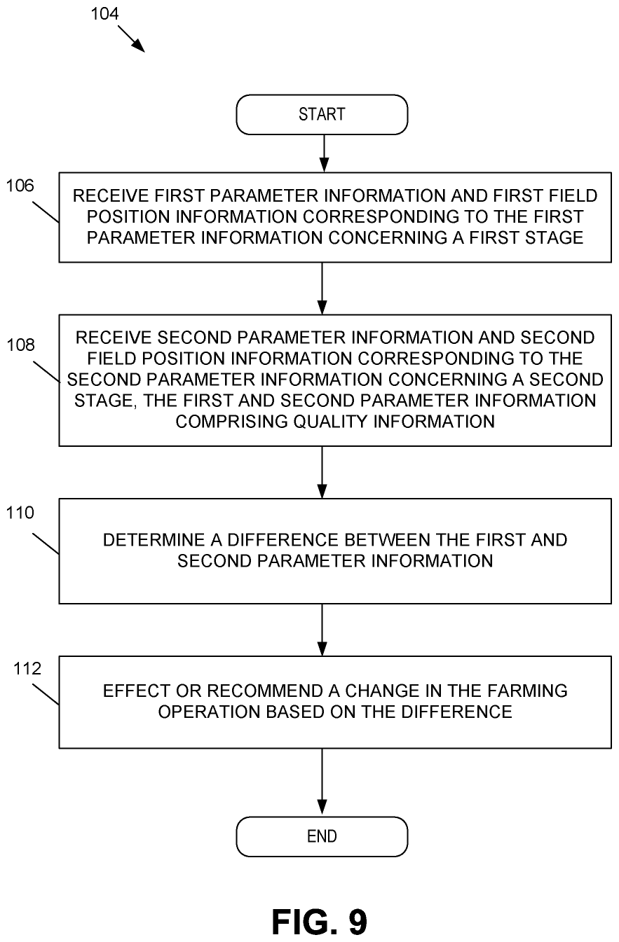

### DESCRIPTION OF EXAMPLE EMBODIMENTS

### Overview

In one embodiment, a method for use in a farming operation comprising plural stages grouped over a first time period, the farming operation implemented over at least the first time period and a second time period, the method comprising: during the first time period: receiving first parameter information and first field position information corresponding to the first parameter information concerning a first stage; receiving second parameter information and second field position information corresponding to the second parameter information concerning a second stage, the first and second parameter information comprising quality information; determining a difference between the first and second parameter information; and effecting or recommending a change in the farming operation based on the difference.

### DETAILED DESCRIPTION

Certain embodiments of a loss monitoring system and method are disclosed that monitor quality measures and associated field positions (e.g., location coordinates) at each stage during a forage harvesting operation, providing valuable feedback and/or adjustment or recommendations of machine settings and/or scheduling for other stages, the current stage in a next time period, or both. In one embodiment, the quality is measured during operations using near infrared (NIR) or other sensing technologies. In some embodiments, loss monitoring systems additionally include yield monitoring at each stage, for instance to measure dry tonnage. The dry tonnage measurements, in combination with quality measurements, enables feedback (e.g., via display) of the yield and/or a monetary value for current operations and/or as a net change (e.g., reduction) when compared to a previous operation(s). Quality and yield (e.g., dry tonnage) information is also referred to herein as parameter information, wherein parameter information may be quality information, yield information, or a combination of both quality and yield information.

In one example operation, as crop is swathed, the quality is recorded and mapped (using field position information) to provide a base quality map for subsequent operations to be measured against. During subsequent operations (e.g., raking, merging, or tedding operations), quality is measured and mapped again. In this case, the raking quality map may be compared to the base map created during swathing to establish the loss (e.g., due to crop respiration), the raking process creating a raking loss measurement or map that can be reported to an operator or owner. The delta between the two quality maps also creates feedback for automation of rake or similar machine settings. Finally, quality may be measured and mapped at the time of baling and compared to either the base quality map created during swathing, the quality map created during raking, or some combination of both. Once again, the delta between maps provides a measure of the loss due to the baling process that can be displayed and fed back for automation of, say, the baler settings to help maximize quality. In some embodiments, a process similar to that performed for quality measurements and maps may additionally or alternatively be performed for yields, where the yield determinations at one stage can be compared to other stage yield determinations and used for the adjustment of machine settings, schedule changes, and/or recommendations involving the same. In some embodiments, the information (e.g., quality measures and/or yield measures) may merely be presented for consumption by an operator or manager, whom in turn can make independent judgments on the appropriate farming modifications to implement based on the information.

Digressing briefly, current forage harvesting systems provide no indicator to operators or managers of losses occurring throughout a forage harvesting operation, which disallows identification of stages that can benefit from best management practices. There is also no current indicator to help automated management of machine settings to help limit or prevent these losses. There are several after market systems that claim to measure quality during baling, but without an indication of the quality prior to baling, it is difficult to determine what effect machine settings are having on quality versus natural quality variations. In contrast, certain embodiments of a loss monitoring system monitors each stage, and even sub-stages (e.g., pre-versus post stage processing), as well as combinations of stages, to better understand where improvements in forage harvest yield may be achieved via adjustments in scheduling operations and/or machine settings.

Having summarized certain features of a loss monitoring system of the present disclosure, reference will now be made in detail to the description of a loss monitoring system as illustrated in the drawings. While an example loss monitoring system will be described in connection with these drawings, there is no intent to limit it to the embodiment or embodiments disclosed herein. For instance, though forage harvesting is described, other farming operations may similarly benefit from a loss monitoring system, and hence are contemplated to be within the scope of the disclosure. Further, although the description identifies or describes specifics of one or more embodiments, such specifics are not necessarily part of every embodiment, nor are all of any various stated advantages necessarily associated with a single embodiment. On the contrary, the intent is to cover all alternatives, modifications and equivalents included within the spirit and scope of the disclosure as defined by the appended claims. Further, it should be appreciated in the context of the present disclosure that the claims are not necessarily limited to the particular embodiments set out in the description.

Note that references hereinafter made to certain directions, such as, for example, “front”, “rear”, “left” and “right”, are made as viewed from the rear of a machine (e.g., self-propelled or towed agricultural machine) looking forwardly.

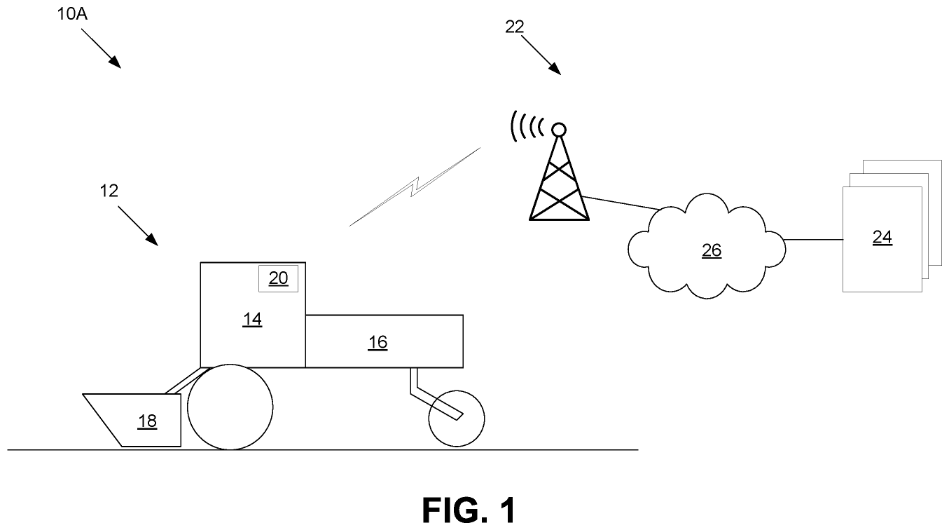

FIG. 1 is a schematic diagram that illustrates, in side elevation view, an example agricultural machine that may be used in an embodiment of a loss monitoring system. In particular, shown is a loss monitoring system 10A comprising a self-propelled windrower (or swather) 12. Though the windrower 12 is depicted as self-propelled, it should be appreciated by one having ordinary skill in the art that in some embodiments, the windrower may be embodied as a pull-type rotary mower that is towed or coupled to another machine, including a tractor, combine harvester, etc. The windrower 12 is operable to mow and collect standing crop in the field, condition the cut material as it moves through the machine to improve its drying characteristics, and then return the conditioned material to the field in a windrow or swath. The windrower 12 includes a chassis or frame supported by wheels (although tracks may be used in some embodiments, or other configurations in the number or arrangement of wheels may be used in some embodiments) for movement across a field to be harvested. The frame carries a cab 14, within which an operator may control operations of the windrower 12, and a rearwardly spaced compartment 16 housing a power source (not shown) such as an internal combustion engine. A harvesting header 18 is supported on the front of the frame in a manner understood by those skilled in the art. The header 18 may be configured as a modular unit and consequently may be disconnected for removal from the frame. The frame may carry a plurality of different types of modular headers designed to perform different harvesting operations. Each side (e.g., left portion, right portion with respect to a centerline of the header) of the header 18 is supported by a respective float cylinder (described below), which are each used to provide a floating function. As is known, the float cylinders apply force to lift arms that hold and carry the header 18. As is also known in the art, the header 18 has a laterally extending crop cutting assembly in the form of a low profile, rotary style cutter bed located adjacent the front of the header 18 for severing crop from the ground as the windrower 12 moves across a field. However, one skilled in the art will understand that other types of crop cutting assemblies, such as sickle style cutter beds, may also be used in some embodiments.

The windrower 12 also includes a computing device 20, which may embodied as a electronic control unit (ECU) that is coupled to a display device. The computing device 20 provides a command and control center for machine operations, and enables the automatic, semi-automatic, and/or manual adjustment of various machine controls, the machine controls including various devices to control navigation, header operation, and/or windrow gathering and forming operations of the windrower 12. The windrower 12 further comprises a plurality of sensors and one or more position devices. For instance, the sensors may be configured to monitor quality of the crop and/or soil, as explained further below, and the position devices (e.g., global navigation satellite systems (GNSS) receiver) is configured to receive field position coordinates (e.g., location, altitude, etc.), which with the quality information, enables the computing device 20 to provide a (base) quality map for the swathing stage that may be used for comparison to other stages. Differences between this base map and later maps may be used to determine appropriate adjustments of machine settings and/or scheduling changes to reduce losses. Additionally, in some embodiments, the windrower 12 includes yield and moisture sensors to enable a determination of dry tonnage from the swathing operation, in addition to enable a comparison to measurements from one or more other stages to present recommendations for changes in certain farming operations and/or to implement machine settings needed to address the yield determinations or losses determined from comparisons with other stages (e.g., from previous operations).

In one embodiment, the computing device 20 comprises a communications interface (e.g., wireless modem, cellular modem, etc.) that enables data to be transmitted and received via a wireless/cellular network 22. The wireless/cellular network 22 may include the necessary infrastructure to enable wireless and/or cellular communications between the computing device 20 and one or more remote computing devices or servers 24 that are coupled to a wide area network 26.

There are a number of different digital cellular technologies suitable for use in the wireless/cellular network 22, including: 3G, 4G, 5G, GSM, GPRS, CDMAOne, CDMA2000, Evolution-Data Optimized (EV-DO), EDGE, Universal Mobile Telecommunications System (UMTS), Digital Enhanced Cordless Telecommunications (DECT), Digital AMPS (IS-136/TDMA), and Integrated Digital Enhanced Network (iDEN), among others, as well as Wireless-Fidelity (Wi-Fi), 802.11, streaming, etc., for some example wireless technologies.

The wide area network 26 may comprise one or a plurality of networks that in whole or in part comprise the Internet. The computing devices 20 may access the one or more server 24 via the wireless/cellular network 22 and/or the Internet 26, which may be further enabled through access to one or more networks including PSTN (Public Switched Telephone Networks), POTS, Integrated Services Digital Network (ISDN), Ethernet, Fiber, DSL/ADSL, Wi-Fi, among others. For wireless implementations, the wireless/cellular network 22 may use wireless fidelity (Wi-Fi) to receive data converted by the devices 20 to a radio format and process (e.g., format) for communication over the Internet 26. The wireless/cellular network 22 may comprise suitable equipment that includes a modem, router, switching, etc.

The servers 24 are coupled to the wide area network 26, and in one embodiment may comprise one or more computing devices networked together, including an application server(s) and data storage. In one embodiment, the servers 24 may serve as a cloud computing environment (or other server network) configured to perform processing required in whole or in part functionality of the loss monitoring system. For instance, functionality of the loss monitoring system may be achieved based on distributed processing performed at the computing device 20 and the server 24, or in some embodiments, based on processing at the server 24 or processing performed at the computing device 20. When embodied as a cloud service or services, the server 24 may comprise an internal cloud, an external cloud, a private cloud, a public cloud (e.g., commercial cloud), or a hybrid cloud, which includes both on-premises and public cloud resources. For instance, a private cloud may be implemented using a variety of cloud systems including, for example, Eucalyptus Systems, VMWare vSphere®, or Microsoft® HyperV. A public cloud may include, for example, Amazon EC2®, Amazon Web Services®, Terremark®, Savvis®, or GoGrid®. Cloud-computing resources provided by these clouds may include, for example, storage resources (e.g., Storage Area Network (SAN), Network File System (NFS), and Amazon S3®), network resources (e.g., firewall, load-balancer, and proxy server), internal private resources, external private resources, secure public resources, infrastructure-as-a-services (IaaSs), platform-as-a-services (PaaSs), or software-as-a-services (SaaSs). The cloud architecture of the servers 24 may be embodied according to one of a plurality of different configurations. For instance, if configured according to MICROSOFT AZURE™, roles are provided, which are discrete scalable components built with managed code. Worker roles are for generalized development, and may perform background processing for a web role. Web roles provide a web server and listen for and respond to web requests via an HTTP (hypertext transfer protocol) or HTTPS (HTTP secure) endpoint. VM roles are instantiated according to tenant defined configurations (e.g., resources, guest operating system). Operating system and VM updates are managed by the cloud. A web role and a worker role run in a VM role, which is a virtual machine under the control of the tenant. Storage and SQL services are available to be used by the roles. As with other clouds, the hardware and software environment or platform, including scaling, load balancing, etc., are handled by the cloud.

In some embodiments, the servers 24 may be configured into multiple, logically-grouped servers (run on server devices), referred to as a server farm. The servers 24 may be geographically dispersed, administered as a single entity, or distributed among a plurality of server farms. The servers 24 within each farm may be heterogeneous. One or more of the servers 24 may operate according to one type of operating system platform (e.g., WINDOWS-based O.S., manufactured by Microsoft Corp. of Redmond, Wash.), while one or more of the other servers 24 may operate according to another type of operating system platform (e.g., UNIX or Linux). The group of servers 24 may be logically grouped as a farm that may be interconnected using a wide-area network connection or medium-area network (MAN) connection. The servers 24 may each be referred to as, and operate according to, a file server device, application server device, web server device, proxy server device, or gateway server device.

In one embodiment, one or more of the servers 24 may comprise a web server that provides a web site that can be used by users interested in accessing quality maps and/or yield maps. For instance, the web site may provide quality maps, yield maps, or difference maps (for quality and/or yield) to assist the operator in adjusting settings and/or scheduling of a given stage of a forage harvesting operation.

The functions of the servers 24 described above are for illustrative purpose only. The present disclosure is not intended to be limiting. For instance, functionality for performing quality loss and/or yield loss monitoring may be achieved at the computing device 20 and/or at a server located proximal to operations (e.g., using edge computing at a farm management office).

Note that cooperation between the computing device 20 and the one or more servers 24 may be facilitated (or enabled) through the use of one or more application programming interfaces (APIs) that may define one or more parameters that are passed between a calling application and other software code such as an operating system, a library routine, and/or a function that provides a service, that provides data, or that performs an operation or a computation. The API may be implemented as one or more calls in program code that send or receive one or more parameters through a parameter list or other structure based on a call convention defined in an API specification document. A parameter may be a constant, a key, a data structure, an object, an object class, a variable, a data type, a pointer, an array, a list, or another call. API calls and parameters may be implemented in any programming language. The programming language may define the vocabulary and calling convention that a programmer employs to access functions supporting the API. In some implementations, an API call may report to an application the capabilities of a device running the application, including input capability, output capability, processing capability, power capability, and communications capability.

In one example operation, the windrower 12 harvests crop in the field and sensors and position devices of the windrower 12 measure the quality and yield and the geographical location of the measurements at a given sampling rate. The sampling may vary depending on the application. In one embodiment, the measurement is of the swath that is formed (e.g., by forming shields), though in some embodiments, the pre-harvested crop and the swath may be monitored. The computing device 20 receives and stores these measurements in local memory and/or communicates the measurements to the server 24. A quality map and/or yield map is generated by the computing device 20 and/or the server 24 for later comparison with other stages of the forage harvesting operation and consequent machine setting adjustments and/or scheduling adjustments for the next stage or same stage at a later time period of operations (e.g., weeks or months later). Comparisons of the quality maps and/or yield maps of different stages may provide insight into where among the stages adjustments in machine settings (e.g., for the swather, conditioning roll gap, forming shield orientation, swath orientation, etc.) and/or scheduling of one or more stage operations may provide a reduction in quality losses and/or yield losses. For instance, if a difference map reveals that quality losses are evident in the swathing stage based on, say, timing of the harvest (e.g., morning, afternoon, etc.), on the next forage harvest, recommendations of timing of the swathing stage may be made. Similarly, if the difference map reveals that quality losses are in the swathing stage based on roll pressure, roll gap, etc., adjustments in machine settings for the current stage harvest may be made, on-the-fly, or recommended to the operator during field operations, to mitigate quality losses (and/or adjustments are made or recommended during a second time period or harvest period for forage harvesting during the swathing stage). Similarly, adjustments (or recommended adjustments) to machine settings (e.g., swather traveling speed) and/or schedules may be made based on the dry tonnage determinations (e.g., compared to historical practice, predefined thresholds/threshold ranges, or configurable settings), where speed is adjusted to lower the moisture content to a suitable amount to reduce microbial carbohydrate consumption (e.g., closer to 60% moisture). As noted above, the quality and/or yield determinations may simply be fed back to the operator (and/or farm manager) to enable informed decisions on farm management practices.

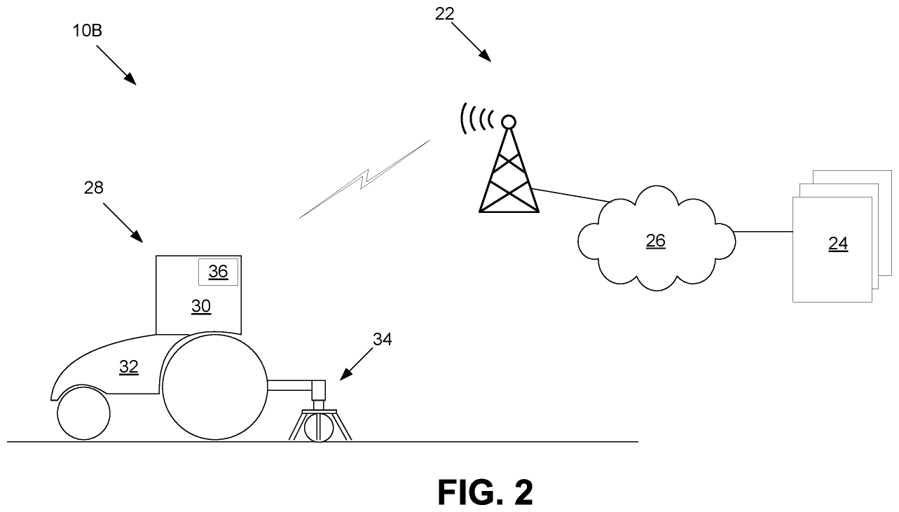

FIG. 2 is a schematic diagram that illustrates, in side elevation view, another example agricultural machine that may be used in an embodiment of a loss monitoring system. For instance, whereas the swathing associated with FIG. 1 may be viewed as a first stage of the forage harvesting operation, the second stage may optionally be a tedding operation. Accordingly, FIG. 2 illustrates a loss monitoring system 10B comprising a tractor 28 comprising a frame supported by wheels or tracks and that supports a cab 30 and engine compartment 32. The tractor 28 is shown coupled rearwardly via a hinge assembly to a tedder 34. As is known, the tedder 34 comprises a gear/transmission assembly powered by the power take-off (PTO) of the tractor 28, the gear/transmission assembly causing rotation of a plurality of tines that serve to engage the windrow to cause the windrow to be stirred or spread out (e.g., to maximize solar radiation exposure underneath the swathed plants). In some embodiments, the tedder 34 may comprise plural, laterally spaced tine groups, each group comprising the tines coupled to a rotating shaft. For instance, any one of the AGCO/Massey Ferguson TD series tedders may a suitable choice of a tedder. Other designs are also contemplated to be within the scope of the disclosure. The tractor 28 comprises a computing device 36, having an architecture similar to the computing device 20 (FIG. 1). The computing device 36 comprises command and control functionality for the tractor 28 and the tedder 34, wherein the computing device 36 may cause adjustment (e.g., via wireless or wired commands) to machine settings (and/or present recommendations to adjust one or more of these settings) of the tedder 34. The tractor 28 and/or tedder 34 may further comprise one or more sensors. In one embodiment, the sensors are used to monitor quality of the crop and/or soil, and may monitor the crop and/or soil before and after the tedder 34, or merely after the tedder 34. The tractor 28 may further comprise a position device (e.g., GNSS receiver) configured to receive field position coordinates (e.g., location, altitude, etc.), which with the quality information, enables the computing device 36 to provide a quality map for the tedding stage and a difference map based on the difference between one or more other maps (e.g., map for the swathing stage, map for a raking stage) and the tedder stage. Similarly, the tractor 28 may include moisture and yield sensors to enable a determination of dry tonnage and losses compared to other stages and/or historical performance, the information provided in some embodiments in the form of a yield map and difference map somewhat similar to that for the quality and difference maps for quality feedback. Such difference maps may be used to determine appropriate adjustments of machine settings and/or scheduling changes to reduce quality and/or yield losses.

Also shown is the wireless/cellular network 22, wide area network 26, and the server(s) 24 which facilitate communications between the computing device 36 and the server(s) 24, as explained above for the computing device 20 (FIG. 1) with similar applicability for communications with the computing device 36, and hence omitted here for brevity.

In one embodiment, the swather map (and yield map) may be communicated to the computing device 36 from the server 24 (e.g., using a communication interface of, or coupled to, the computing device 36). For instance, the computing device 20 (FIG. 1) may communicate (e.g., upload) the base quality and yield maps to the server 24 (e.g., using FTP, HTTP, etc., among other file transfer protocols). At start-up or based on geofence detection (e.g., the tractor 28 arriving at a field for which swathing operations have recently occurred), the computing device 36 may receive (e.g., upon request or automatically) the quality and yield map for the prior stage of forage harvesting operations (e.g., the swathing stage). As the tedder 34 is towed and operational through the field, the quality and yield are measured by sensors associated with the tedder 34 and, along with position information (e.g., determined via the position device of the tractor 28), a quality map and yield map are generated and difference maps are generated based on the difference between the quality and yield measures for respective field positions during the tedding operation and the quality and yield measures for corresponding field positions determined during the swathing operation. In some embodiments, the quality map and the yield map may be determined as the tedder 34 is towed and operational through the field, but the difference maps may be determined at a lower sampling rate (or post tedding operations). In some embodiments, the base maps for the swathing phase may already reside in memory of the computing device 36, such as where the tractor 28 was also used in the swathing operation (e.g., towing a windrower as opposed to using a self-propelled windrower) and hence the computing devices 20 and 36 are one in the same.

In some embodiments, the quality map and yield map of the swathing stage may be uploaded to the computing device 36 via transfer of detachable memory between the computing device 20 and computing device 36. For instance, a portable memory (e.g., memory stick) may store the quality and yield maps from the swathing stage, and the operator may withdraw the memory stick from an I/O port (e.g., USB port) of the computing device 20 and insert the memory stick into an I/O port (e.g., USB port) of the computing device 36, where the quality and yield maps of the swathing stage are uploaded to the computing device 36 memory. In some embodiments, the quality and yield maps of the swathing stage may be wirelessly transferred directly (or indirectly via a local area network) from the computing device 20 to the computing device 36 (e.g., using Bluetooth, near field communications, etc.) or a wireless protocol (e.g., wireless fidelity). For instance, the operator of the tractor 28 may request a wireless transfer from the computing device 20 residing in the windrower 12, or based on proximity of the computing devices 20, 36 to each other (or to an intermediate computing device supporting the local area network) and prior authorization, the transfer may occur automatically (or semi-automatically, such as requiring permissions as presented on a display device before proceeding with the transfer). It is noted that the mechanical stirring of the windrow runs the risk of damage to the leaf structure of the windrowed crop, particularly if the plants are dried down considerably, and hence proper machine settings and/or scheduling of the tedder stage is important to reduce loss of quality and/or yield. It is noted that there may be situations (e.g., such as based on the intended consumer and/or the region) when more emphasis is placed on quality than yield, and at other times, vice versa. For instance, there may be situations where there is a loss for a given amount of either quality, or yield, where the total monetary loss per acre is not greater than the monetary loss that may be incurred by, for instance, slowing down the machine (e.g., to optimize performance). Accordingly, settings for machine setting adjustments (e.g., from default values from the manufacturer) and/or when triggering alerts or certain requests for intervention before making adjustments, and/or even the goal of certain recommendations, may be included in certain embodiments for an operator or farm manager or other responsible personnel to configure based on the particular application or goals of the farm. In other words, enabling the producer to set thresholds for the given settings and/or operations enables the producer to manage their unique requirements for operations (e.g., when looking in the context of through-put versus loss tradeoffs).

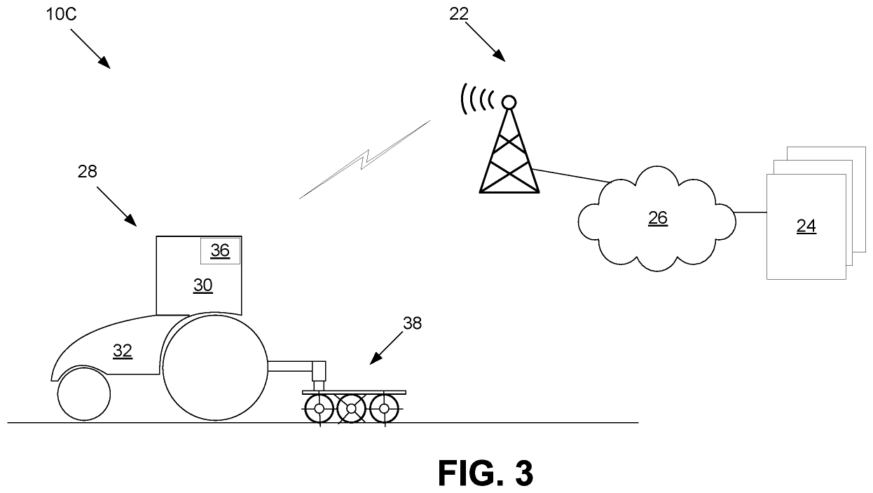

FIG. 3 is a schematic diagram that illustrates, in side elevation view, another example agricultural machine that may be used in an embodiment of a loss monitoring system. In the loss monitoring system 10C depicted in FIG. 3, aside from the machine used in a raking/merger stage in place of the tedder 34, the components/equipment shown in FIG. 2 are included here and hence description of the like-numbered components/equipment are omitted here for brevity. Note that in some embodiments, a different towing machine may be used, and hence one or any combination of the base quality map or quality map of the tedding stage may be accessed from the server 24 or communicated or transferred to the computing device of the other stage machine in a similar manner as described above in association with FIGS. 1-2. In the depicted embodiment, the loss monitoring system 10C comprises a raking machine 38 (or simply, rake) towed by (e.g., via a hitch assembly) and operably coupled to the tractor 28 (e.g., via the PTO). The rake 38 may be configured as a rotary rake with a central gear box that enables rotation of plural arms having plural tines attached thereto (e.g., such as the Massey Ferguson RK series of rakes), as plural pivoting wheel rakes mounted in pairs (e.g., such as the Massey Ferguson 1500, 3900, or 5130 series), or other configures as are known in the industry. The rake 38 is used to form the windrow into a larger one. In some embodiments, a merger may be used in place of the rake, where the windrow is collected on a draper assembly to form a larger windrow while removing ash (e.g., dirt) and/or mitigating stand damage.

In one example operation, the computing device 36 receives the quality and yield maps (e.g., quality and yield measurements and corresponding geographical locations or coordinates) of a prior stage (e.g., the tedder and/or swather stage). For instance, the computing device 36 may have the quality and yield maps of the prior stage stored in memory (e.g., if the tractor 28 was used in the prior stage). In some embodiments, the computing device 36 may receive the quality and yield maps of the prior stage after accessing or receiving a download from the server 24 (automatically, or based on request). In some embodiments, the quality and yield maps of the prior stage may be communicated over a local area network or via low range communications (e.g., Bluetooth, near field communications, wireless fidelity, etc.) from another computing device of or associated with the prior stage machine. In some embodiments, the prior stage quality and yield maps may be stored in portable memory that is connected to the computing device 36 by the operator. As the tractor 28 pulls the rake 38 across the field, the computing device 36 receives quality and yield measurements (e.g., via sensors located on or proximal to the rake) and corresponding field position information (e.g., via GNSS functionality on the tractor 28) and generates quality and yield maps for the rake stage. During field operations, or in some embodiments, subsequent to field operations, the computing device 36 determines a difference map based on the quality and yield maps of the prior stage and the current-stage quality and yield maps, and uses the difference information to provide recommended or update machine settings and/or schedule changes in the machine for a later field pass of the current stage, or for another stage machine.

Notably, research reveals that raking represents a stage with significant potential for reduction in quality loss. The quality difference map (and yield difference map) may enable adjustments in ground engagement, rotor speed (e.g., on rotary rakes), ground speed, time of day for raking, and/or adjustments for moisture levels (e.g., at or around 30% moisture levels, raking may cause significant damage). In contrast, current techniques are much more subjective, such as an operator walking out to the field at the beginning of the day, and touching the windrow to prompt a speculation or subjective assessment of the moisture level in the windrow and whether it is time to rake. Or, a crew leader may command operators to go to the field with even less real time information, and the operators rake the field windrow without providing any additional assessment of the quality (e.g., moisture level) of the windrow. Objective information made possible by certain embodiments of a loss monitoring system provides for improved farm management and improved yields from farming/harvesting operations.

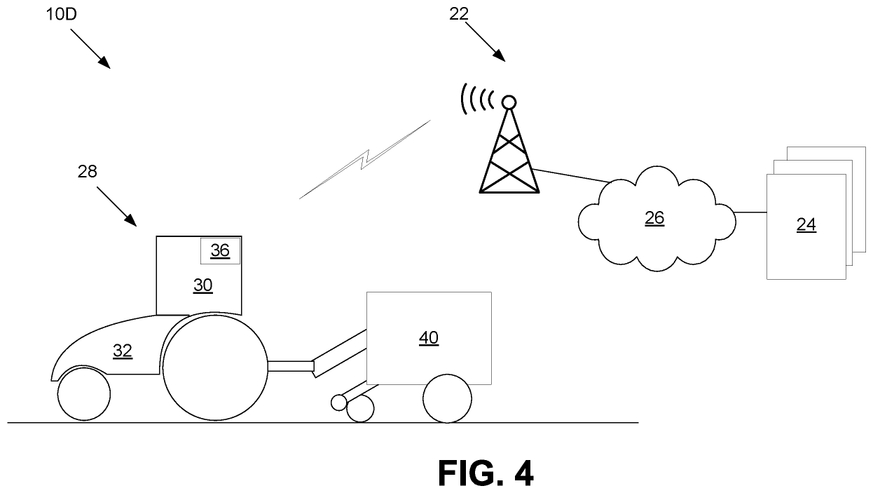

FIG. 4 is a schematic diagram that illustrates, in side elevation view, another example agricultural machine that may be used in an embodiment of a loss monitoring system. The only difference between the loss monitoring system 10D and the loss monitoring system 10C (FIG. 3) is the use of a different forage harvesting machine, namely, the use of a baler 40 in a baling stage for the loss monitoring system 10D in place of the rake 38 (or merger in some embodiments) in the raking (or merging) stage of the prior forage harvesting stage. Accordingly, description of like-numbered components/equipment are omitted here for brevity. The baler 40 is used in a baling stage to collect the windrow and form into round (for round balers) or square/rectangular (for square balers) bundles. Suitable balers include the 1800 series small square balers, series 2200 large square balers, 2900 series round balers, or 4100 series round balers by Massey Ferguson, among other designs and/or manufacturers.

In one example operation, the computing device 36 receives the quality and yield maps (e.g., quality and yield measurements and corresponding geographical locations or coordinates) of a prior stage (e.g., the rake/merger stage). For instance, the computing device 36 may have the quality and yield maps of the prior stage stored in memory (e.g., if the tractor 28 was used in the prior stage). In some embodiments, the computing device 36 may receive the quality and yield maps of the prior stage after accessing or receiving a download from the server 24 (automatically, or based on request). In some embodiments, the quality and yield maps of the prior stage may be communicated over a local area network or via low range communications (e.g., Bluetooth, near field communications, wireless fidelity, etc.) from another computing device of or associated with the prior stage machine. In some embodiments, the prior stage quality and yield maps may be stored in portable memory that is connected to the computing device 36 by the operator. As the tractor 28 pulls the baler 40 across the field, the computing device 36 receives quality and yield measurements (e.g., via sensors located on or proximal to the baler 40) and corresponding field position information (e.g., via GNSS functionality on the tractor 28) and generates quality and yield maps for the baler stage. During field operations, or in some embodiments, subsequent to field operations, the computing device 36 determines difference maps based on the quality and yield maps of the prior stage and the current-stage quality and yield maps, and uses the difference information to provide recommended (or to update automatically) machine settings and/or schedule changes in the machine for a later field pass of the current stage, or for another stage machine.

Note that in the embodiments described in association with FIGS. 1-4, though the difference maps are described as based on the prior stage quality and yield maps, difference maps may be generated based on the difference between other prior stage maps. For instance, in the case of the baler stage, the computing device 36 may generate difference maps based on the quality and yield maps of the swather stage and the quality and yield maps of the baler stage. Additionally, the difference maps may provide a basis for changes in one or more stages. For instance, difference maps created at the baler stage may lead to adjustments in machine settings or scheduling at more than one stage, including at the baler stage for the current harvest (e.g., in real time, making adjustments in the aggressiveness of the baling window), the schedule (e.g., timing) of when the next harvest raking should take place, and/or the direction of the swath at the next time period (e.g., next harvest). Also, as indicated above, sensors may be positioned to monitor the result of the harvest stage (e.g., monitor the output of the machine), though in some embodiments, sensors may be placed before and after the machine (e.g., for the baler, prior to pick-up and another sensor arranged to monitor the output of the baler). Other variations or combinations are contemplated to be within the scope of the disclosure.

It should be appreciated by one having ordinary skill in the art in the context of the present disclosure that not all measured losses will necessarily trigger adjustments in, or recommendations for, machine settings and/or scheduling for one or more stages. In some embodiments, ranges and/or thresholds may be defined (e.g., as predetermined or configurable settings) where a certain level of loss is tolerated as a natural result of the inherent production inefficiencies expected in practice in farming operations, and/or based on the diverse and sometimes conflicting goals among different farmers or farming operations (e.g., where elements of productivity are sacrificed for quality or vice versa).

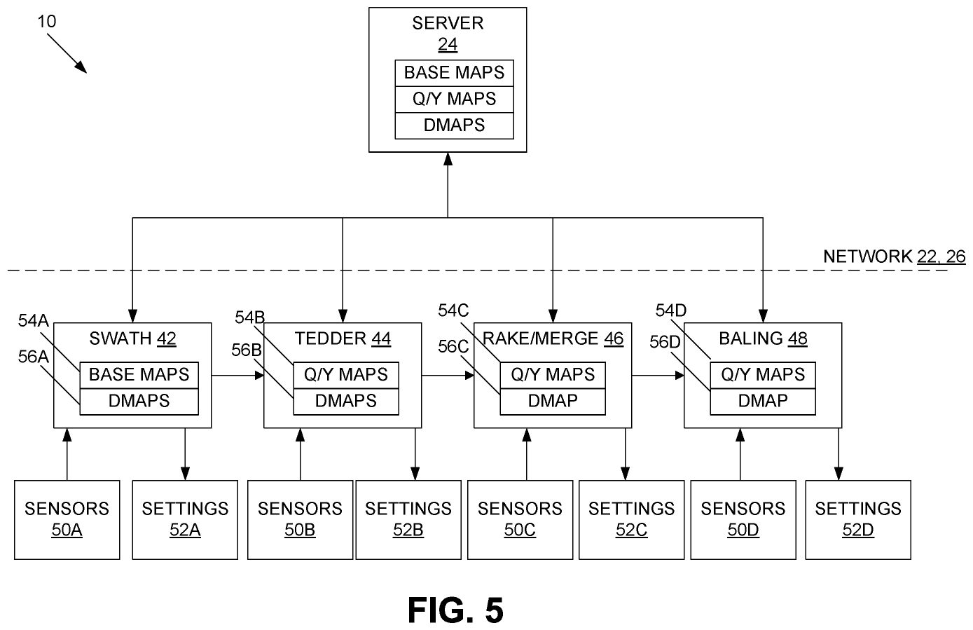

FIG. 5 is a block diagram that illustrates one embodiment of an example loss monitoring system 10 used for plural machines in a farming (e.g., harvesting) operation. The loss monitoring system 10 shown in FIG. 5 comprises the plural stages for the loss monitoring systems 10A-10D of FIGS. 1-4. As shown, the loss monitoring system 10 comprises computing devices, sensors, and machine controls that cooperate over one or more networks to monitoring quality and yield during the stages of a harvesting operation over one or more time periods (e.g., a first time period comprises a harvest using the plural stages during a span of days, weeks or months, a second time period comprises a second harvest at another, non-overlapping span of days, weeks or months, etc.). Note that some embodiments may only monitor quality, while some embodiments may only monitor yield. In some embodiments, both quality and yield are monitored. In one embodiment, the loss monitoring system 10 comprises the server 24 (or plural servers) coupled over one or more networks 22, 26 to computing devices that perform the functions of monitoring operations of plural stages of the forage harvesting operation. In particular, the computing devices perform swath monitoring 42, tedder monitoring 44, rake/merge monitoring 46, and baling monitoring 48. In some embodiments, the computing devices used for one or more stages may be a shared computing device (e.g., where the computing device is used in more than one stage), and in some embodiments, the computing devices for the monitoring 42-48 may be different between two or more stages. Each of the monitoring 42-48 involves sensing 50a-50d and machine setting adjustments/recommendations or scheduling adjustments/recommendations 52a-52d (collectively and individually referenced as settings in FIG. 5). The sensors 50 include quality and yield measurements and position location determinations (e.g., using GNSS receiving functionality). The quality and yield measurements, and position measurements, may be used to generate quality and yield (Q/Y) maps 54 that are stored as a result of the monitoring 42-48, and difference maps 56 may be generated (at the computing device associated with one of the stages or at the server 24) based on quality and yield maps 54 communicated or transferred from computing devices of other stages. In some embodiments, the settings 52 may also be communicated to one or more other stages.

For instance, for the swath monitoring 42, base quality and yield maps 54a are generated based on the sensing 50a, and the base quality and yield maps and/or difference maps 56a (generated based on quality maps and yield maps from one or more other stages) may be used to provide or recommend machine setting or schedule adjustments/recommendations 52a. The base quality and yield maps 54A may be communicated to one or more other stages 44, 46, and/or 48 for the determination of respective difference maps. For instance, the base quality and yield maps 54A may be communicated to the tedder monitoring 44. The base quality and yield maps 54A and/or the difference maps 56a may be communicated to the server 24.

For the tedder monitoring 44, quality and yield maps 54b are generated based on the sensing 50b, and the quality and yield maps 54b and/or difference maps 56b may be used to provide or recommend machine setting or schedule adjustments/recommendations 52b (e.g., for the tedder). The difference maps 56b are generated based on the base quality and yield maps 54a and the quality and yield maps 54b. The quality and yield maps 54b and/or the difference maps 56b may be communicated to the server 24. The quality and yield maps 54b are communicated to another stage, including the next stage involving the rake/merge monitoring 46.

For the rake/merge monitoring 46, quality and yield maps 54c are generated based on the sensing 50c, and the quality and yield maps 54c and/or difference maps 56c may be used to provide or recommend machine setting or schedule adjustments/recommendations 52c (e.g., for the rake or merge machine). The difference maps 56c are generated based on the quality and yield maps 54b and the quality and yield maps 54c. The quality and yield maps 54c and/or the difference maps 56c may be communicated to the server 24. The quality and yield maps 54c are communicated to another stage, including the next stage involving the baling monitoring 48.

For the baling monitoring 48, quality and yield maps 54d are generated based on the sensing 50d, and the quality and yield maps 54d and/or difference maps 56d may be used to provide or recommend machine setting or schedule adjustments/recommendations 52d (e.g., for the baler). The difference maps 56d are generated based on the base quality and yield maps 54c and the quality and yield maps 54d. The quality and yield maps 54d and/or the difference maps 56d may be communicated to the server 24. The quality and yield maps 54d are communicated to another stage, including the swather stage involving the swath monitoring 42.

Note that the difference map determinations described above are illustrative of one embodiment, and that variations to the above description are contemplated. In some embodiments, the difference maps 56 may involve one or more (e.g., all) of the combinations of quality and/or yield maps based on the respective stages used: [(pre-raking)-(swathing)], [(post-raking)-(pre-raking)], [(post-raking)-(swathing)], [(baling)-(post-raking)], [(baling)-(swathing)].

The settings 52 are used in different ways depending on the stage at play. For instance, the settings 52a for swathing are based on the baseline quality and yield measurements or maps 54a, and are used for future decisions for the next field or cutting. In one embodiment, the settings 52a include scheduling information (e.g., when to swath, including time of day, growth stage), how to swath (e.g., match directions of travel with the rake), alternating directions to maximize field efficiency), and/or one or more other settings, including travel speed, header speed (e.g., knife speed for cutoff, conditioner speed for crimping and/or windrow formation), condition type (e.g., running rubber “crush” rolls, steel crimp rolls, or in embodiments using double conditioner headers, some combination of the two), conditioner roll gap, conditioner roll pressure, header tilt, header cutoff height, header float pressure, swathboard/forming shield positions/orientations, knife type (e.g., different knife pitch, where tradeoff is feeding versus ash due to increased turbulence at the knife).

As another example, for settings 52c at the raking/merging stage, rake settings may be used in future and real time implementations. Such settings 52c may include one or more of scheduling decisions on when to rake (e.g., based on the sensed moisture content at the time of raking), how to rake (e.g., raking with the direction of swathing as opposed to against the swathing direction), rake type (e.g., wheel rake, rotary rake, merger), and/or one or more other settings including forward travel speed, rake height/ground engagement, rotor speed (e.g., for rotary rakes), belt speed (e.g., for mergers), or based on windrow width. Note that the settings adjustment for any stage can be to the towed implement (e.g., rake), to the towing machine (e.g., the tractor), or a combination of both.

As yet another example, for settings 52d, real time feedback or adjustment/recommendations may be implemented, including when to bale (e.g., based on sensed moisture content, direction of travel) and/or one or more of PTO revolutions per minute (RPM), pickup RPM, travel speed, flake size, pre-chamber dimensions, plunger load, chamber door pressure, or bale weight.

The quality and yield measurements at each monitoring stage 42-48 are based on sampling measurements of the sensors 50. The sampling rate may vary depending on desired information resolution, data storage and/or bandwidth, speed or processing, among other parameters. For instance, sampling may be performed according to a temporal sampling rate (e.g., every second or sub-second, every five (5) seconds, every nine (9) seconds, etc.), where the objectives of the harvesting operation/management and ability for an operator to sufficiently digest such information, in addition to the other parameters, may dictate the chosen sampling rate. In some embodiments, differences in sampling depends on the operational stage. For instance, during baling 48, the process for providing feedback to an operator may be more sophisticated than for one or more other stages (e.g., where sampling intervals may be longer, such as every two seconds, to filter out normal variations and/or improve operator experience).

Further, the quality measurements are chosen according to the demands or desires of the particular harvesting operation, which may vary depending on region. In general, plant material (e.g., of the windrow) is generally graded on crude protein and relative feed value (RFV), which refers to the measure of fiber to enable an understanding of how much a domestic animal (e.g., a cow) will eat and how much the animal may digest. In other words, the quality measurement is associated with the quality of hay, and typically, RFV or protein makes up about ninety (90) percent of that quality measure. For instance, with industry knowledge that crop such as alfalfa possesses lower quality fiber and protein in the stem and the leaf is more valuable in that regard, one way to maximize potential for reducing quality loss is determining how to get more of the leaf portions of the plant into the animal. The quality monitoring at each stage of forage harvesting provides tools to the operator and/or farm manager to exploit conditions in a way to reduce quality losses and increase the yield that is consumed by the animal.

In one embodiment, the quality measurements involve assessment of acid detergent fiber (ADF), neutral detergent fiber (NDF), RFV (e.g., calculated from ADF/NDF), and crude protein (CP). In some embodiments, quality measurements may further involve assessment of sugars, ash, etc. In some embodiments, quality measurements may be based on industry measurement packages. For instance, quality measurements may involve a plurality of different components, including dry matter (DM), CP, soluble powder (SP), runoff dissolved phosphorus (RDP), acid detergent fiber insoluble crude protein (ADICP), neutral detergent fiber insoluble crude protein (NDICP), estimated lysine & methionine, ADF, aNDF, lignin, starch, water soluble carbohydrate (WSC), ESC (simple sugars), non-fiber carbohydrates (NFC), fat, trifluoroacetic acid (TFA), RUFAL, ash, RFV, relative forage quality (RFQ) (with 48 hr neutral detergent fiber digestibility (NDFD)), MILK2006 (index) values, total digestible nutrients (TDN), NEI, NEm, NEg, ME, DE, Ca, P, Mg, K, S, Cl. Other measures may be used depending on the application.

The sensors 50 collectively include the quality and yield measurements and position detection (e.g., using a GNSS receiver, triangulation, etc.). In one embodiment, the quality measurement involves use of near infrared sensors. In one embodiment, each near infrared sensor comprises a wide-spectrum photodetector that delivers its output to the computing device (or an intermediate processing device that communicates with the computing device). The computing processes the data from the sensor 50, where plural wavelengths (e.g., three or more) from the processed data are further used to process the data using calibration models to generate a prediction from the raw data. Such processing may be performed on the fly (e.g., in real time) in some embodiments. In some embodiments, plural overlapping narrow band photodetectors may be used, which in some embodiments may be implemented using microelectromechanical systems or MEMS technology. For yield sensing, a variety of sensing technologies may be used. For instance, yield sensing may involve sensing/determinations of total mass and moisture sensing to derive dry tonnage. Mass measurements may be sensed using force paddles, capacitive-based sensing, optical measurements, among other known technology. Moisture sensing, which may also be involved in quality measurements, may involve one or a more of electrical conductivity, microwave, near IR, capacitive, among others. The data from these sensors may be used to derive a dry tonnage (e.g., factoring out the moisture from the mass measurements).

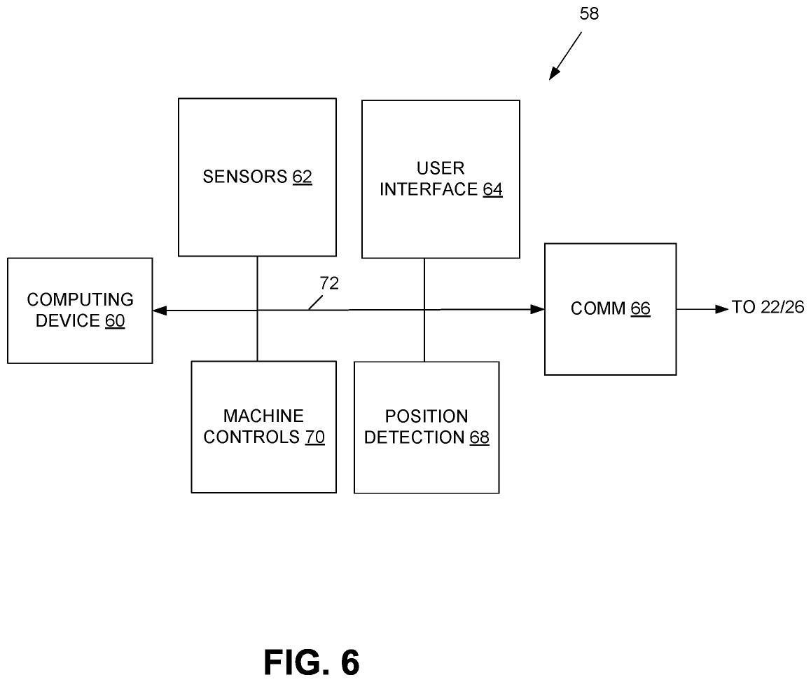

FIG. 6 is a block diagram that illustrates one embodiment of an example loss monitoring system 58 for a machine used for one or more stages of a farming operation. In other words, the loss monitoring system 58 may reside in the swather, tractor or other vehicle towing an implement, and/or in the tedder, rake/merger, or baler. In other words, the depicted components of the loss monitoring system 58 may reside in or on a single machine, or be located in distributed fashion among multiple machines (e.g., the towing and towed machine). The functionality of the loss monitoring system 58 is the same or similar to the loss monitoring system 10 described in association with FIGS. 1-5, except with the server 24 omitted from the figure. It should be appreciated within the context of the present disclosure that some embodiments may include additional components or fewer or different components, and that the example depicted in FIG. 6 is merely illustrative of one embodiment among others. In the depicted embodiment, the loss monitoring system 58 comprises a computing device 60, one or more sensors 62, a user interface 64, a communications interface 66, a position detection device 68, and machine controls 70, all coupled together via one or more networks, such as network 72 (e.g., a CAN network or other network, such as a network in conformance to the ISO 11783 standard, also referred to as “Isobus”). Note that variations to the type or quantity of devices are contemplated to be within the scope of the disclosure, including the use of plural computing devices, or the incorporation of one of the components into the other (e.g., sensors 62 may include the position detection device functionality).

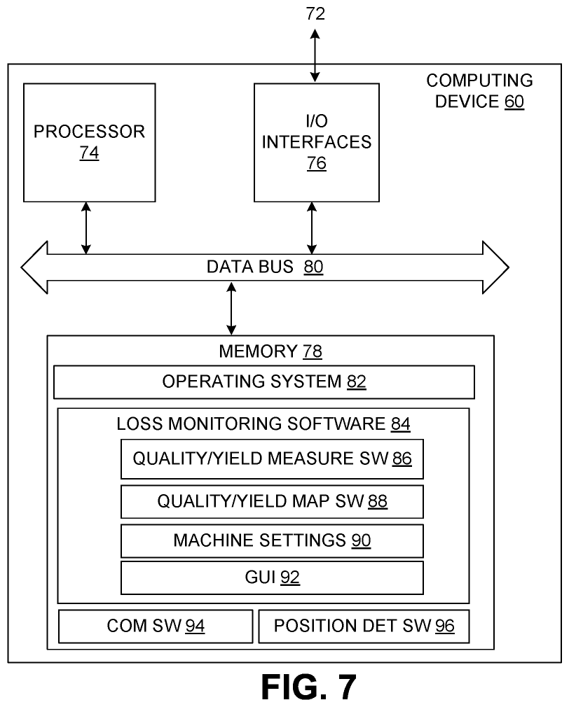

The computing device 60, described further below in association with FIG. 7, provides a command and control node for the loss monitoring system 58. The computing device 60 provides software (e.g., including software, firmware, microcode, etc.) that enables the control of operations of the host machine and coupled machine (e.g., towed tedder, rake, merger, and baler) via the network 72. For instance, the computing device 60 receives quality and yield measurements (e.g., raw and processed by the computing device, or processed data) from the sensors 62 and corresponding position information from the position detection device 68 and prepares and renders (e.g., on the user interface 64) a quality map and a yield map. In some embodiments, the content of each of these maps may be combined into a single map, but will be described as different, individual maps in the description above and below. In some embodiments, the computing device 60 receives via the communications interface 66 (or via access to memory of the computing device 60 or from remote storage (e.g., of the server 24)) quality and yield maps for another stage and prepares respective difference maps based on the received quality and yield maps and the quality and yield maps determined for the current stage. In some embodiments, the quality and yield maps for the current and other stage (e.g., prior stage) are uploaded to the server 24, which generates the difference maps (quality and yield difference maps) and provides the difference maps to the requesting computing device 60. The computing device 60 also determines adjustments to machine controls 70 based on the difference maps, and stores the setting adjustments internally and/or remotely (via sending to the server 24 via communications interface 66) for subsequent use or recommendations. The settings adjustments to the machine controls 70 may involve settings for the host machine or towed machine (e.g., the tedder, rake/merger, baler), or a combination of both. In some embodiments, the adjustments may be made automatically for the current field, next field, next harvest (e.g., same stage), and/or another stage. In some embodiments, the setting adjustments to the machine controls 70 may be performed semi-autonomously (e.g., adjusted automatically based on operator or manager interaction, such as via a prompt providing a rendered recommendation or in some embodiments, an audible recommendation that requires operator input to acknowledge or authorize or deny the adjustment), or manually (e.g., based on the visual or audible recommendation, the operator or manager makes the necessary adjustments manually). In some embodiments, the adjustments may be made to a calendar or scheduling app resident in the computing device 60 or resident in the server 24, where the adjustments or recommendations are communicated to the calendar or scheduling app with or without user intervention. As noted above, triggers for adjustments and/or recommendations, or the types of recommendations, may be configurable by the operator or other responsible personnel, such as through a settings screen prompted in the cab or at another computing device (e.g., smartphone, laptop, personal computer, etc.). The different settings may enable changes in one or more defaults based on the particular applications and/or goals for the given farm operations.

The sensors 62 comprise the necessary functionality to measure forage quality and yield and sense machine operations. The sensors 62 may reside on the windrower 12 (FIG. 1), the tractor 28 (FIG. 2), the tedder 34 (FIG. 2), the rake 38 (FIG. 3, or merger), and on the baler 40 (FIG. 4). The sensors 62 that perform quality and yield monitoring may reside on the windrower 12, the tedder 34, the rake 38 (or merger), and the baler 40. In some embodiments, the sensors may monitor forage quality and yield before and after the windrower 12, the tedder 34, the rake 38 (or merger), and the baler 40, and in some embodiments, may reside in the tractor 28 (or other towing vehicle). As set forth above, the quality (and in some embodiments, yield) monitor sensors comprise near infrared technology that uses a wide range of wavelengths to interrogate the crop material, providing real time or near real time spectrum analysis for a plurality of different molecules (e.g., proteins, fiber etc.). The yield sensors may include moisture sensing and mass sensing that collectively may involve force paddles, capacitive, conductivity, microwave, or optical sensors, among others. In some embodiments, weight scales may be used for at least a portion of the mass sensing, such as where equipped on balers for each discharged bale. The sensors 62 also include those used in conjunction with machine controls 70. For instance, the sensors 62 may provide the computing device 60 with feedback to provide feedback control associated with the machine controls. For instance, the sensors 62 may include a variety of sensor types suitable to monitor, as appropriate for the machine operations, ground speed, header speed, roll gap, roll pressure, header tilt, cutoff height, header float pressure, knife pitch, forming shield orientation/position, rake height, rotor speed, belt speed, PTO RPM, pickup RPM, flake size, plunger load, chamber door pressure, and bale weight, among other operations/parameters. The sensors 62 may be embodied as contact (e.g., electromechanical sensors, such as position sensors, strain gauges, pressure sensors, distance measurement, etc.) and non-contact type sensors (e.g., photo-electric, inductive, capacitive, ultrasonic, etc.), all of which comprise known technology. The sensors may include pressure or position/distance sensors, micro-switches, potentiometers, strain gauges, piezo sensors, capacitive sensors, load sensors, drag-type sensors, ground speed sensors, transmission/transaxial sensors, angle sensors (e.g., rotary encoders), acoustic sensors, tilt sensors, and/or optical sensors (e.g., array or strip sensors, LIDAR, CMOS sensors, charge-coupled devices, cameras). Sensors 62 may be wired to the computing device 60 or wirelessly coupled to the computing device 60.

The user interface 64 may include one or more components, including one or any combination of a keyboard, mouse, microphone, touch-type or non-touch-type display device (e.g., display monitor or screen), joystick, steering wheel, FNR lever, and/or other devices (e.g., switches, immersive head set, etc.) that enable input and/or output by an operator. For instance, in some embodiments, the user interface 64 may comprise a display device that the computing device 60 uses to render a quality map graphic, yield map graphic, and/or difference maps for each to the operator, or in some embodiments, values underlying the quality/yield and/or difference maps (e.g., quality measurements, yield measurements, position information). In some embodiments, the user interface 64 may be used to prompt recommendations to the operator, including recommended settings, or that a setting adjustment is impending and inviting the operator to accept or deny the adjustment. In some embodiments, a help icon may be presented to further explain the basis for the recommended or impending adjustment. In some embodiments, the user interface 64 may merely provide an update to the operator that adjustments in settings have taken place, with or without additional explanation.

The communications interface 66 may comprise a wireless modem, cellular modem, or a combination of both to access the network 22 and enable communications with the server 24. For instance, the computing device 60 may access the server 24 via communications interface 66 to receive quality and yield maps from other stages, quality and yield measurements and corresponding position information from other stages, or in embodiments where difference and/or quality and yield maps are determined remotely, send quality and yield measurements and position information to the server 24, and receive quality and yield maps for the current stage or difference maps based on the current stage and other stages. In some embodiments, the server 24 may be accessed for mapping/navigational apps, topography maps, etc. The communications interface 66 may work in conjunction with communication software (e.g., including browser software) in the computing device 60, or in some embodiments, may interface with a wireless device (e.g., a smartphone of an operator, such as via Bluetooth technology) to enable cellular communications. The communications interface 66 may comprise MAC and PHY components (e.g., radio circuitry, including transceivers, antennas, etc.), as should be appreciated by one having ordinary skill in the art.

The position detection device 68 comprises functionality for determining a geographical location (e.g., field location) of the machine during a given stage. The location may include position coordinates and altitude, and may be sampled every second, sub-second, or every several seconds. In one embodiment, the position detection device 68 may be embodied as a GNSS receiver (e.g., global positioning system (GPS) receiver), though other satellite-based systems may be used (e.g., GLONASS). In some embodiments, the position detection device 68 may comprise other technologies, such as position detection based on triangulation. The position detection device 68 may further include inertial components (e.g., gyroscope). In some embodiments, the computing device 60 may use the GNSS functionality of a smartphone of an operator residing in the cab of the machine. Generally, the position detection device 68 resides in the towing or self-propelled machine (e.g., the windrower or tractor).

The machine controls 70 include actuators (e.g., solenoid, motors, switches, relays, etc.) that operate in conjunction with machine components to control their operation. For instance, hydraulic control valves may comprise a solenoid that receives control signals from the computing device 60 and accordingly alters the flow to and/or from a hydraulic cylinder, such as to effect a tilt of a header, or a header lift, among others desired effects. In some embodiments, the actuators may work in conjunction with electrical or electromagnetic valves. In some embodiments, the actuators may comprise motors that are used to effect a change in operation, or electromagnetic switches or relays. The actuator may comprise motor control logic, an air valve, a solenoid, among other controlling devices or components.

With continued reference to FIG. 6, attention is now directed to FIG. 7, which illustrates an embodiment of an example computing device 60 that may be used in a loss monitoring system. One having ordinary skill in the art should appreciate in the context of the present disclosure that the example computing device 60 is merely illustrative, and that some embodiments of computing devices may comprise fewer or additional components, and/or some of the functionality associated with the various components depicted in FIG. 7 may be combined, or further distributed among additional modules, in some embodiments. It should be appreciated that, though described in the context of residing in one of the machines (e.g., windrower 12, FIG. 1, tractor 28, FIG. 2), in some embodiments, the computing device 60, or all or a portion of its corresponding functionality, may be implemented in a computing device or system located external to the machines (e.g., serving the functionality of the server 24, FIG. 1). Referring to FIG. 7, the computing device 60 is depicted in this example as a computer, but may be embodied as an electronic control unit (ECU), programmable logic controller (PLC), field programmable gate array (FPGA), application specific integrated circuit (ASIC), among other devices. It should be appreciated that certain well-known components of computers are omitted here to avoid obfuscating relevant features of the computing device 60.

In one embodiment, the computing device 60 comprises one or more processors (also referred to herein as processor units or processing units), such as processor 74, input/output (I/O) interface(s) 76, and memory 78, all coupled to one or more data busses, such as data bus 80. The memory 78 may include any one or a combination of volatile memory elements (random-access memory RAM, such as DRAM, and SRAM, etc.) and nonvolatile memory elements (e.g., ROM, Flash, hard drive, EPROM, EEPROM, CDROM, etc.). The memory 78 may store a native operating system, one or more native applications, emulation systems, or emulated applications for any of a variety of operating systems and/or emulated hardware platforms, emulated operating systems, etc.

In the embodiment depicted in FIG. 7, the memory 78 comprises an operating system 82 and loss monitoring software 84, which in one embodiment comprises quality/yield measurement software 86, quality/yield map software 88, machine settings adjust software 90, and a graphical user interface (GUI) software 92. The memory 78 further comprises communications software 94 and position detection software 96. It should be appreciated that in some embodiments, additional or fewer software modules (e.g., combined functionality) may be deployed in the memory 78 or additional memory. In some embodiments, a separate storage device may be coupled to the data bus 80, such as a persistent memory (e.g., optical, magnetic, and/or semiconductor memory and associated drives).

The loss monitoring software 84 receives sensor input from one or more of the sensors 62 and input over the network 72 from the user interface 64 via the I/O interfaces 76. For instance, the quality/yield measurement software 86 receives the raw or processed quality and yield measurements from the sensors 62. The raw data may be processed by the quality/yield measurement software 86, which in one embodiment, comprises a prediction engine to predict the quality measures. For instance, input from the near IR sensors 62 are processed (e.g., smoothing operations, derivatives) by the quality/yield measurement software 86, with a result of plural spectrum peaks that are each further processed (e.g., weighting, noise-filtering, regression, etc.), and for each wavelength (e.g., among plural wavelengths in a defined range), a calibration performed and provided to a prediction engine to compute a respective score for the different crop constituents described above for quality assessment (e.g., crude protein score, etc.). In some embodiments, prediction may be implemented at the sensors 62 or an intermediate device, and the quality measurements provided to the quality/yield measurement software 86. The quality/yield measurement software 86 also receives in association with the quality and yield measurements position data from the position detection device 68 under the control of the position detection software 96. For instance, satellite data is received at the position detection device 68, and provided over the network 72 and I/O interfaces 76 to the quality/yield measurement software 86. In some embodiments, position information may be determined via the communications interface 66 under the control of the communications software 94. In one embodiment, the quality and yield measurements and corresponding position information (e.g., for each quality and yield measurement, the corresponding position in the field is recorded) are stored in memory 78, such as in a data structure (e.g., database), where the data may be accessed to provide via the communications interface 66 to another computing device (e.g., the server 24 and/or another stage computing device if different than computing device 60). The quality and yield measurements and corresponding field positions may be accessed from memory 78 and used by the quality/yield map software 88 to determine a quality map, yield map, and/or corresponding difference maps.

The quality/yield map software 86 uses the stored quality and yield measurements and corresponding field positions to determine quality and yield maps. For instance, the quality/yield map software 86 may use maps (stored locally or remotely) of the field in which the current stage is being implemented and integrate the quality and yield measurements and corresponding field positions with the field map (e.g., by matching field positions). The quality/yield map software 86 is further configured to provide difference maps (e.g., quality and yield difference maps). For instance, the quality/yield map software 86 may compare the quality and yield measurements of the quality and yield maps for the current stage with quality and yield maps determined from another stage (e.g., received via the server 24, via another computing device (e.g., used in another stage), or directly (via memory stick transfer), as explained above), and provide difference maps for the current stage based on the differences. The quality and yield maps for the current stage may be communicated to the server 24, stored in memory 78, or communicated to another computing device.

Based on the quality and yield maps and/or difference maps, the machine settings adjust software 90 may determine adjustments to machine settings that lead to improvements in harvesting operations for the current stage in the current time period or a different time period, or for adjustments in machine settings for other machines (e.g., in other stages). The setting adjustments may be stored in memory 78 for application in a next field, the remaining field, or for future harvesting for the current stage during another time period. In some embodiments, the setting adjustments may be communicated to another computing device (e.g., the server 24 and/or a computing device involved in another stage if different than the current computing device). The setting adjustments may be determined according to a rules engine or through artificial intelligence (e.g., learning or deep learning algorithms). In some embodiments, recommendations for the setting adjustments may be stored for later communication to an operator, such as via the user interface 64. In other words, though some embodiments may provide for automatic setting adjustments, some embodiments may require authorization for the automatic setting adjustments (e.g., by the user or manager), and some embodiments may require manual entry of the adjustments based on the recommended setting adjustments. In some embodiments, the machine settings adjust software 90 further includes scheduling adjustments or recommendations for scheduling adjustments, which may be communicated to the server 24 (e.g., for feedback to a farm manager, entry in a calendar, etc.) or stored in memory 78 for later application.

The GUI software 92 comprises graphics functionality to render the quality maps and yield maps and/or difference maps generated by the quality/yield map software 88 onto a user interface (e.g., a display device). The quality and yield maps and/or difference maps may be generated in real time, or at predetermined time intervals during field operations. In some embodiments, the quality and yield maps and/or difference maps comprise the map of the field and delineated contours or polygons or colored polygons, the contours comprising quality and yield values for respective maps or, in the case of colored polygons (e.g., squares representing incremental blocks of the field), differences in color based on the quality and yield measurements or the quality and yield losses.

Note that in some embodiments, the quality and yield data may be indicated to the operator (e.g., visual and/or aural feedback), and adjustments and/or recommendations may be omitted in favor of more operator or farm management independence. In some embodiments, additional information may be provided. For instance, yield maps may include an economic feature in addition to or in lieu of the yield data, such as yield cost per defined area (e.g., per acre) or profit level per acre.

Execution of the loss monitoring software 84, including the comprises quality/yield measurement software 86, quality/yield map software 88, machine setting adjust software 90, and a graphical user interface (GUI) software 92, and the communications software 94 and position detection software 96, may be implemented by the processor 74 under the management and/or control of the operating system 82. The processor 74 may be embodied as a custom-made or commercially available processor, a central processing unit (CPU) or an auxiliary processor among several processors, a semiconductor based microprocessor (in the form of a microchip), a macroprocessor, one or more application specific integrated circuits (ASICs), a plurality of suitably configured digital logic gates, and/or other well-known electrical configurations comprising discrete elements both individually and in various combinations to coordinate the overall operation of the computing device 60.

The I/O interfaces 76 provide one or more interfaces to the network 72 and other networks. In other words, the I/O interfaces 76 may comprise any number of interfaces for the input and output of signals (e.g., analog or digital data) for conveyance of information (e.g., data) over the network 72. The input may comprise sensor input and input by an operator through the user interface 64, and the output may comprise setting adjustments to the machine controls 70 or to another computing device via the communications interface 66 and quality and yield measurements, corresponding field positions, and/or map renderings to the user interface 64 (and/or to the server 24).

When certain embodiments of the computing device 60 are implemented at least in part with software (including firmware), as depicted in FIG. 7, it should be noted that the software can be stored on a variety of non-transitory computer-readable medium for use by, or in connection with, a variety of computer-related systems or methods. In the context of this document, a computer-readable medium may comprise an electronic, magnetic, optical, or other physical device or apparatus that may contain or store a computer program (e.g., executable code or instructions) for use by or in connection with a computer-related system or method. The software may be embedded in a variety of computer-readable mediums for use by, or in connection with, an instruction execution system, apparatus, or device, such as a computer-based system, processor-containing system, or other system that can fetch the instructions from the instruction execution system, apparatus, or device and execute the instructions.

When certain embodiment of the computing device 60 are implemented at least in part with hardware, such functionality may be implemented with any or a combination of the following technologies, which are all well-known in the art: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc.

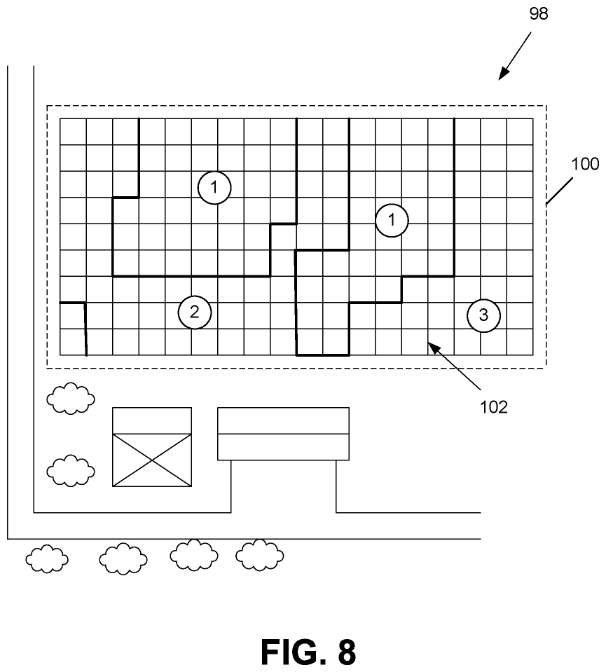

Referring now to FIG. 8, shown is an example quality map 98 that may be provided by a loss monitoring system. It should be appreciated by one having ordinary skill in the art in the context of the present disclosure that the quality map 98 depicted in FIG. 8 is one illustrative example, and that variations to the format, information provided, etc. may be implemented and used to provide a quality map of a different format or design. It is noted that the difference map may also have a similar format, as does a yield map or difference map for yield. The quality map 98 comprises an underlying map (e.g., which may be formatted as a satellite view, or a graphical representation of a geographic map) of a field(s) 100 (e.g., the boundaries of which are represented in FIG. 8 as dashed lines), and an overlaid grid 102 comprising differences in color (or texture in some embodiments) based on the differences in quality measures. In the example depicted in FIG. 8, regions delineated by boldface lines are labeled with numbers 1-4 to signify that those regions comprise grid blocks or squares with different colors, textures, or other visually distinctive marks (e.g., reference numeral 1 may represent the color red, reference numeral 2 may represent yellow, etc.). Thus, the grid 102 comprises a plurality of squares representing defined areas of the field. In some embodiments, though the squares of the grid 102 are shown as uniform, in some embodiments, the squares may be of different sizes. In some embodiments, the squares may be replaced with other polygons of the same or different dimensions and/or shapes. In some embodiments, the quality map 98 may comprise additional information. For instance, quality measures may be overlaid on each grid square or each region of the same color/texture, or links or icons may be presented that open a dialogue box when selected to show additional information (e.g., field coordinates, a component breakdown of the quality measurement or the overall quality measurement, etc.). Note that the quality map 98 depicted in FIG. 8 is merely a simplified example, with the recognition that there may be finer resolution and/or additional (or fewer) color differences in practice. Also, the description above for the quality map 98 has similar applicability to the yield map.

In view of the above description, it should be appreciated that one embodiment of a loss monitoring method 104 for use in a farming operation (e.g., forage harvesting operation) comprising plural stages grouped over a first time period, the farming operation implemented over at least the first time period and a second time period, the method 104 implemented by a computing device, comprises: during the first time period: receiving first parameter information and first field position information corresponding to the first parameter information concerning a first stage (106); receiving second parameter information and second field position information corresponding to the second parameter information concerning a second stage, the first and second parameter information comprising quality information (108); determining a difference between the first and second parameter information (110); and effecting or recommending a change in the farming operation based on the difference (120). For instance, the recommended change may be a machine setting adjustment and/or schedule change. In some embodiments, a display of information (no recommendations or change in settings) may be implemented, enabling individual management of farming operations based on the unique needs of that particular farming operation. In some embodiments, the first and second quality information may instead be yield information. In some embodiments, the first and second quality information may comprise quality and yield information, where the differences are computed for both quality and yield and changes effected and/or recommended based on the quality and yield differences.

Any process descriptions or blocks in flow diagrams should be understood as representing modules, segments, or portions of code which include one or more executable instructions for implementing specific logical functions or steps in the process, and alternate implementations are included within the scope of the embodiments in which functions may be executed out of order from that shown or discussed, including substantially concurrently or in reverse order, depending on the functionality involved, as would be understood by those reasonably skilled in the art of the present disclosure.

In this description, references to “one embodiment”, “an embodiment”, or “embodiments” mean that the feature or features being referred to are included in at least one embodiment of the technology. Separate references to “one embodiment”, “an embodiment”, or “embodiments” in this description do not necessarily refer to the same embodiment and are also not mutually exclusive unless so stated and/or except as will be readily apparent to those skilled in the art from the description. For example, a feature, structure, act, etc. described in one embodiment may also be included in other embodiments, but is not necessarily included. Thus, the present technology can include a variety of combinations and/or integrations of the embodiments described herein. Although the control systems and methods have been described with reference to the example embodiments illustrated in the attached drawing figures, it is noted that equivalents may be employed and substitutions made herein without departing from the scope of the disclosure as protected by the following claims.

At least the following is claimed:

1. A computing system for use in a farming operation comprising plural stages grouped over a first time period, the farming operation implemented over at least the first time period and a second time period, the computing system comprising:
a computing device configured to:
during the first time period:
receive first parameter information and first field position information corresponding to the first parameter information concerning a first stage;
receive second parameter information and second field position information corresponding to the second parameter information concerning a second stage, the first and second parameter information comprising one or a combination of quality information and yield information;
determine a difference between the first and second parameter information; and
effect or recommend a change in the farming operation based on the difference.

2. The system of claim 1, wherein the first and second stages comprise one of the following combinations:
swathing and tedding;
tedding and pre-raking;
swathing and pre-raking;
swathing and post-raking;
pre-raking and post-raking;
post-raking and baling; or
swathing and baling.

3. The system of claim 2, further comprising additional stages, wherein the computing device is further configured to receive additional parameter information and corresponding field position information corresponding to the combinations and determine corresponding differences and effect or recommend a change in the farming operation based on the differences.

4. The system of claim 1, wherein the computing device is configured to effect or recommend the change in the farming operation by storing a machine setting for a machine implementing the second stage, the second stage occurring during the first time period or the second time period.

5. The system of claim 4, further comprising one or machine controls, wherein the computing device is configured to adjust the one or more machine controls based on the stored machine setting.

6. The system of claim 5, further comprising a display device, wherein prior to the adjustment, the computing device is configured to render on the display device a recommendation to adjust the one or more machine controls based on the stored machine setting.

7. The system of claim 1, wherein the computing device is configured to effect the change in the farming operation by adjusting a schedule or recommending a revised schedule for implementing the second stage during the second time period.

8. The system of claim 7, further comprising a display device, wherein the computing device is configured to render on the display device a recommendation to revise the schedule.

9. The system of claim 1, further comprising a communications interface, wherein the computing device is further configured to communicate one or a combination of the second parameter information or difference to one or more other computing devices via the communications interface.

10. The system of claim 1, wherein the computing device is further configured to provide one or more first maps based on the first parameter information and the first field position information, one or more second maps based on the second parameter information and the second field position information, and one or more difference maps based on the determined difference.

11. The system of claim 10, further comprising a display device, wherein the computing device is further configured to render one or any combination of the one or more first maps, the one or more second maps, or the one or more difference maps on the display device.

12. The system of claim 1, further comprising:
one or more sensors configured to provide the first parameter information, the second parameter information, or a combination of the first and second parameter information to the computing device; and
a position location device configured to provide the first field position information, the second field position information, or a combination of the first and second field position information to the computing device.

13. A method for use in a farming operation comprising plural stages grouped over a first time period, the farming operation implemented over at least the first time period and a second time period, the method comprising:
during the first time period:
receiving first parameter information and first field position information corresponding to the first quality information concerning a first stage;
receiving second parameter information and second field position information corresponding to the second quality information concerning a second stage, the first and second parameter information comprising quality information;
determining a difference between the first and second parameter information; and
effecting or recommending a change in the farming operation based on the difference.

14. The method of claim 13, wherein the first and second stages comprise one of the following combinations:
swathing and tedding;
tedding and pre-raking;
swathing and pre-raking;
swathing and post-raking;
pre-raking and post-raking;
post-raking and baling; or
swathing and baling.

15. The method of claim 14, wherein the parameter information further comprises yield information.

16. The method of claim 13, further comprising effecting or recommending the change in the farming operation by storing a machine setting for a machine implementing the second stage, the second stage occurring during the first time period or the second time period.

17. The method of claim 16, further comprising adjusting one or more machine controls based on the stored machine setting automatically or based on user input responsive to a rendered recommendation to make the adjustment.

18. The method of claim 13, further comprising effecting the change in the farming operation by adjusting a schedule or recommending a revised schedule for implementing the second stage during the second time period.

19. The method of claim 13, further comprising providing a first map based on the first parameter information and the first field position information, a second map based on the second parameter information and the second field position information, and a difference map based on the determined difference.

20. A non-transitory computer readable medium comprising instructions that are executed by one or more processors to:
during a first time period:
receive first parameter information and first field position information corresponding to the first parameter information concerning a first stage;
receive second parameter information and second field position information corresponding to the second parameter information concerning a second stage, wherein the first and second parameter information comprises one or a combination of quality information and yield information;
determine a difference between the first and second parameter information; and
effect or recommend a change in a farming operation based on the difference.
